(19) United States
(12) Patent Application Publication
(10) Pub. No.: US 2010/0116032 A1
(43) Pub. Date: May 13, 2010

(54) SENSOR ELEMENT AND CONSISTENCY TRANSMITTER

(75) Inventor: Olli P. Ruosaari, Tampere (FI)

Correspondence Address: OLIFF & BERRIDGE, PLC, P.O. BOX 320850, ALEXANDRIA, VA, 22320-4850, US

(73) Assignee: Metso Automation Oy, Helsinki (FI)

(21) Appl. No.: 12/450,962

(22) PCT Filed: Apr. 25, 2008
(86) PCT No.: PCT/FI2008/050227

§ 371 Date: Nov. 18, 2009

(30) Foreign Application Priority Data
Apr. 27, 2007 (FI) U20070173

(51) Int. Cl. G01N 11/14

(52) U.S. Cl. 73/54.28

(57) ABSTRACT

A sensor element for a consistency transmitter for use in measurements of a pulp suspension and coated with a diamond coating. A consistency transmitter for measuring the consistency of a pulp suspension, comprising: a sensor element to be placed in the pulp suspension and provided with a diamond coating; a part provided with equipment for measuring the force/torque effective on the sensor element, for processing the force/torque by computation, and for converting the force/torque to an electrical signal; and a transmitting element, connected to the sensor element and said part, for transmitting the force/torque effective on the sensor element to said part. A method in the manufacture of a sensor element for a consistency transmitter for use in measurements of a pulp suspension, wherein the method comprises the step of coating the sensor element with a diamond coating.

### FIELD OF THE INVENTION

The invention relates to a sensor element for a consistency transmitter used in measurements of pulp suspension. The invention relates to a consistency transmitter for measuring the consistency of a pulp suspension. The invention relates to a method in the manufacture of a sensor element for a consistency transmitter for use in measurements of a pulp suspension.

### BACKGROUND OF THE INVENTION

Consistency transmitters based on shear force measurement are known for the measurement of consistencies of pulp suspensions. In these transmitters, a sensor element, i.e. a measuring sensor, is placed in a flow channel system or the like conveying the suspension, and the actual measuring element is placed outside the channel system to be measured. The sensor element is connected to a transmitting element that transmits the force and/or movement of the suspension effective on the sensor element by the moment principle to a measuring element outside the flow channel system. The measuring element measures a force dependent on the moment effective on the transmitting element, the force being proportional to the consistency of the pulp.

There are three types of sensor elements used in shear force measurements: blade-like, substantially stationary sensor elements; blade-like, active sensor elements; and rotor-like, rotary sensor elements. The type of the sensor element selected for the measurement will depend, among other things, on the consistency of the pulp and on the process measurement point.

In the production of pulp, wood chips are cooked in an alkaline water solution. As a result of the cooking, the fibres and lignin of the wood separate from each other, and lignin dissolves in the cooking solution. After cooking the pulp is washed, wherein the fibrous pulp can be separated from the lignin-containing cooking solution.

Wood also contains a number of other substances besides lignin and fibres, such as fatty acids and resins, which are commonly called extractives. Most of the extractives dissolve in the cooking solution during the cooking, but a large amount of them still remains in the finished pulp. Especially hardwood pulp contains large amounts of neutral extractives after the cooking. The extractives in hardwood pulp consist mainly of unsaturated fatty acids which are mainly found in the small-sized parenchymatous cells in the pulp. The extractives may also appear on the surface of the fibres or freely in the solution.

The extractives cause numerous problems in the steps of further processing of the pulp. The extractives freely in the solution are agglomerated and form deposits, gums and precipitates in the process devices and transmitters and their parts which come into contact with the pulp.

In view of the reliability of consistency measurements, a problem is caused by the formation of extractive deposits on the surface of sensor elements. It has been found in practice that impurity deposits sticking to the surface of the sensor elements cause distortions in the measurement results towards higher consistencies than the real values. For this reason, the transmitter must be calibrated considerably more frequently than normally. The calibration of the consistency transmitter is a time-consuming operation. It requires manual laboratory measurements of pulp samples by means of which the transmitter can be calibrated. Furthermore, the sensor element must be cleaned at intervals of 4 to 8 weeks.

Attempts have been made to prevent the soiling of the sensor element by coating the sensor element with a Teflon or titanium coating, but these have not lead to satisfactory results.

### BRIEF SUMMARY OF THE INVENTION

The aim of the present invention is thus to provide a sensor element in which the above-mentioned problems are eliminated and which gives accurate and reliable measurement results when used in a consistency transmitter.

To attain this purpose, the sensor element according to the invention is characterized in the appended claim 1. The consistency transmitter for measuring the consistency of a pulp suspension is characterized in the appended claim 5. The method in the manufacture of a sensor element for a consistency transmitter for use in measurements of a pulp suspension is characterized in the appended claim 8.

The invention is based on the idea that the sensor element used in a consistency transmitter for measuring a pulp suspension is coated with a diamond coating. The diamond-coated sensor element will substantially not be soiled or covered by extract deposits on its surface. As a result, the reliability of the measurement is improved. Furthermore, the intervals of calibration and cleaning of the sensor element can be prolonged.

Pilot tests have shown that a sensor element coated with a diamond coating remains clean for a substantially longer time than sensor elements coated with known coatings, such as Teflon or titanium. Furthermore, the diamond coating is almost perpetual. It is a very hard material which is not scratched or worn like the above-mentioned conventional coatings for sensor elements.

### BRIEF DESCRIPTION OF THE DRAWINGS

In the following, the invention will be described in more detail with reference to the appended drawings, in which

FIG. 1 shows a schematic cross-section of a consistency transmitter based on a blade-like sensor element and placed in connection with a pulp flow channel system,

FIG. 2 shows various blade-like sensor elements,

FIG. 3 shows a schematic cross-section of a consistency transmitter based on a rotary sensor element and placed in connection with a pulp flow channel system, and

FIG. 4 shows various rotary sensor elements.

### DETAILED DESCRIPTION OF THE INVENTION

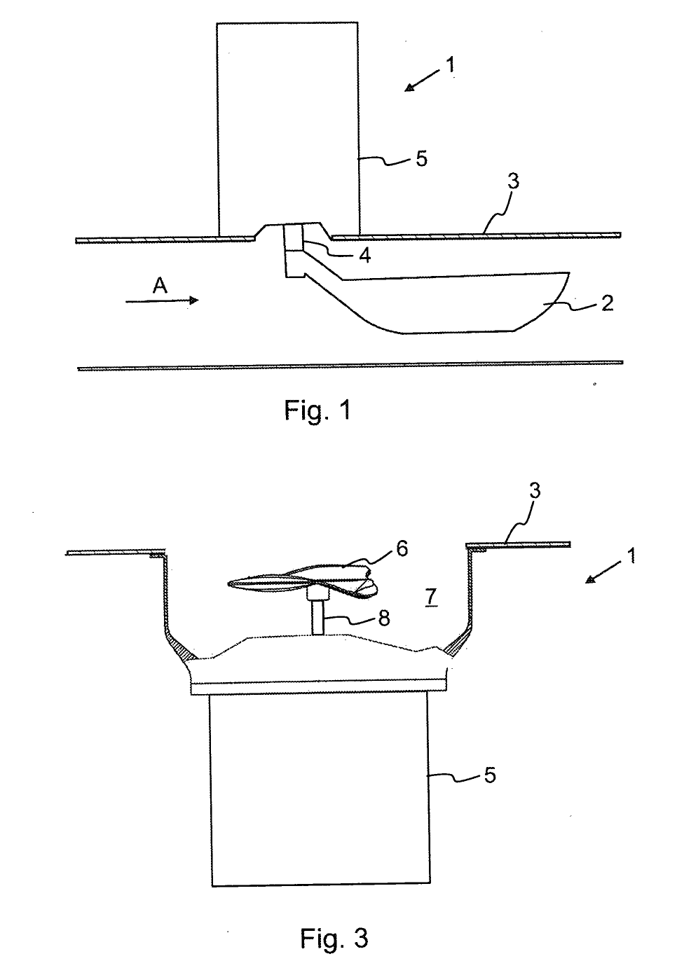

FIG. 1 shows the cross-section of a consistency transmitter 1 based on shear force measurement and comprising a blade-like sensor element 2. The blade-like sensor element 2 may be either a stationary sensor element or an active blade-like sensor element. The consistency transmitter 1 is placed in connection with a pulp flow channel 3. The sensor element 2 is fitted inside the flow channel 3 for conveying pulp, in the pulp suspension flow, when the consistency transmitter is installed in position. Connected to the sensor element 2 is a transmitting element 4 which is, at its other end, connected to a part 5 of the consistency transmitter 1 outside the flow channel 3.

The pulp suspension flowing in the flow channel 3 (arrow A) subjects the sensor element 2 to a force effect whose magnitude is proportional to the consistency of the suspension. The transmitting element 4 transmits the force effective on the sensor element 2 to the part 5 of the consistency transmitter 1 outside the flow channel 3, provided with equipment for measuring the force effective on the sensor element, for computing it and for converting it to an electrical signal. The parts of the consistency transmitter shown in FIG. 1 and the function of the transmitter are known as such for a person skilled in the art, wherein they will not be described in more detail in this context.

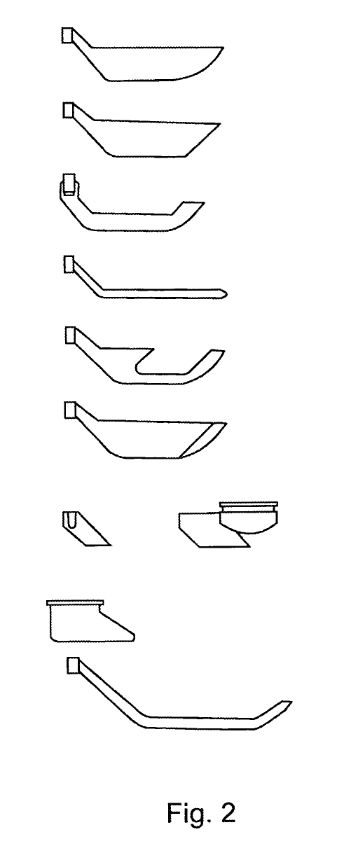

FIG. 2 shows ten different blade-like sensor elements 2 whose design varies to a great extent. For each object to be measured, the sensor element which is most suitable for the respective process conditions is selected. The selection of the sensor element is influenced, among other things, by the consistency of the pulp and the location of measurement in the process.

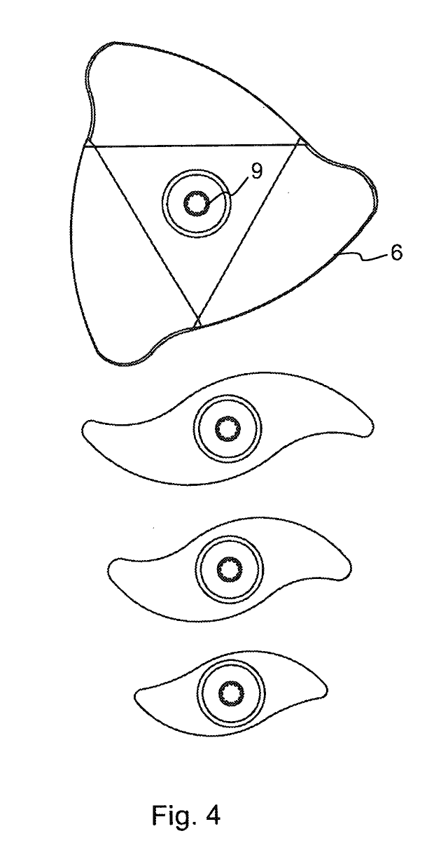

FIG. 3 shows the cross-section of a consistency transmitter 1 based on shear force measurement and comprising a rotary sensor element 6. The consistency transmitter 1 is placed in connection with a pulp flow channel 3. The wall of the flow channel 3 conveying the pulp is provided with a measurement chamber 7, in which the sensor element 6 is fitted when the consistency transmitter is installed in position. Thus, during the measurement, the sensor element 6 is in the pulp suspension of the flow channel conveying pulp. Connected to the sensor element 6 is a transmitting element 8, around which the sensor element 6 rotates during the measurement. The transmitting element 8 is, at its other end, connected to a part 4 of the consistency transmitter 1 outside the flow channel 3.

The consistency of the pulp suspension is proportional to the torque generated in the transmitting element 8. The transmitting element 8 transmits the torque caused by the rotation of the sensor element 6 to the part 5 of the consistency transmitter 1 outside the flow channel 3, provided with equipment for measuring the torque, for processing it by computation, and for converting it to an electrical signal. The parts of the consistency transmitter shown in FIG. 1 and the function of the transmitter are known as such for a person skilled in the art, wherein they will not be described in more detail in this context.

FIG. 4 shows four different sensor elements 6 which are intended to be rotated by a transmitting element 8. The sensor elements 6 have a through hole 9 for connecting one end of the transmitting element 8 to the sensor element 6. The sensor elements are different in their shape, and the selection of the sensor element for each object of measurement is influenced, among other things, by the consistency of the pulp and the site of measurement in the process.

The sensor elements shown in FIGS. 2 and 4 are made of a durable material, such as acid-proof steel, and they are coated throughout by a diamond coating. The coating of the sensor elements is performed, for example, by the vacuum deposition technique at a low temperature. The diamond coating technique is known as such for a person skilled in the art, wherein it will not be described in more detail in this context.

The invention is not intended to be limited to the embodiments presented as examples above, but the invention is applied according to the appended claims.

1. A sensor element for a consistency transmitter for use in measurements of a pulp suspension, wherein the sensor element is coated with a diamond coating.

2. The sensor element according to claim 1, wherein the sensor element is a blade-like sensor element.

3. The sensor element according to claim 1, wherein the sensor element is a rotary sensor element.

4. The sensor element according to claim 1, wherein the sensor element is arranged in a flow channel conveying the pulp suspension.

5. A consistency transmitter for measuring the consistency of a pulp suspension, comprising: a sensor element to be placed in the pulp suspension; a part provided with equipment for measuring the force/torque effective on the sensor element, for processing the force/torque by computation, and for converting the force/torque to an electrical signal; and a transmitting element, connected to the sensor element and said part, for transmitting the force/torque effective on the sensor element to said part; wherein the sensor element is provided with a diamond coating.

6. The consistency transmitter according to claim 5, wherein the sensor element is a blade-like sensor element, the sensor element is arranged stationary or active; or a rotary sensor element, and the sensor element is arranged rotatable by means of the transmitting element.

7. The consistency transmitter according to claim 5, wherein the sensor element is placed or is to be placed in the pulp suspension flow inside a flow channel for conveying pulp.

8. A method in the manufacture of a sensor element for a consistency transmitter for use in measurements of a pulp suspension, comprising: coating the sensor element with a diamond coating.

9. The method according to claim 8, wherein coating the sensor element is performed by a vacuum deposition technique at a low temperature.

10. The method according to claim 8, wherein the sensor element is made of acid-proof steel.

11. The sensor element according to claim 2, wherein the sensor element is arranged in a flow channel conveying the pulp suspension.

12. The sensor element according to claim 3, wherein the sensor element is arranged in a flow channel conveying the pulp suspension.

13. The consistency transmitter according to claim 6, wherein the sensor element is placed or is to be placed in the pulp suspension flow inside a flow channel for conveying pulp.

14. The method according to claim 9, wherein the sensor element is made of acid-proof steel.
